(19) United States
(12) Patent Application Publication
(10) Pub. No.: US 2009/0287535 A1
(43) Pub. Date: Nov. 19, 2009

(54) SYSTEM AND METHOD FOR TRACKING DATA

(76) Inventor: Matt Jennings, Ham Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/121,385

(22) Filed: May 15, 2008

(51) Int. Cl. G06Q 50/00; G06Q 10/00

(52) U.S. Cl. 705/10; 705/15

(57) ABSTRACT

In one embodiment, the method comprises operating one or more commercial appliances and establishing an event count each time a preparation event is carried out in the commercial appliance. The method further comprises communicating each event count to a database and maintaining event count information at the database. The method further comprises operating one or more point of sale interfaces for processing customer orders and communicating customer order information to a database and maintaining customer order information at the database. The method then comprises generating operating reports, the operating reports being based on the event count information and/or customer order information.

### FIELD OF THE INVENTION

The present disclosure relates to a system and method for tracking data related to the preparation and sale of food in a restaurant. More particularly, the present disclosure relates to a system and method for tracking the amount of a food product a restaurant prepares relative to the amount the food product it sells and a system and method for tracking the estimated time between the preparation of a food product and the sale of the food product to customers.

### BACKGROUND

After preparation of a food product, several statistics may be relevant to restaurants for purposes of optimizing customer satisfaction and/or profit. For example, the amount of a food product a restaurant prepares relative to the amount the food product it sells, or the food product yield, may be of interest to a restaurant. Maximizing the food product yield may, for example, have a dramatic effect on the profitability of a restaurant.

An additional relevant statistic is the elapsed time between the preparation of a food product and the sale of the food product to a customer, or food product hold time. Such a statistic may be of particular concern for food products in which exposure to ambient conditions significantly degrades the quality of the end-product, such as for example fried foods, and especially french fried potatoes. After frying, french fried potatoes exhibit a crisp and tender exterior surface and a fluffy, mealy inner core. After a short holding period, however, they lose their desired crispness and tend to become limp and soggy, thereby significantly inhibiting product quality and customer satisfaction.

Currently, however, there are no known systems or methods to automate calculation of such statistics.

### BRIEF SUMMARY OF THE INVENTION

A system and method for tracking data related to the preparation and sale of food in a restaurant is provided. More particularly, a system and method for tracking the amount of a food product a restaurant prepares relative to the amount the food product it sells and a system and method for tracking the estimated time between the preparation of a food product and the sale of the food product to customers are provided.

In one embodiment, the method comprises operating one or more commercial appliances and establishing an event count each time a preparation event is carried out in the commercial appliance. The method further comprises communicating each event count to a database and maintaining event count information at the database. The method further comprises operating one or more point of sale interfaces for processing customer orders and communicating customer order information to a database and maintaining customer order information at the database. The method then comprises generating operating reports, the operating reports being based on the event count information and/or customer order information.

In a further embodiment, a food product tracking system is provided. The food product tracking system comprises one or more commercial appliances, at least one control box, one or more point of sale interfaces, a database, and a central processor. The control box is operatively associated with the one or more commercial appliances such that control box counts preparation events of the commercial appliance. The database stores information relating to preparation events and customer orders and is in communication with the control box such that the control box sends information regarding counted preparation events to the database. The database is also in communication with the point of sale interfaces such that the point of sale interface sends information regarding customer orders to the database. The central processor is operatively associated with the database and includes software for tracking food product information.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a block diagram depicting a food product monitoring system in accordance with some embodiment of the present disclosure.

FIG. 2 is a block diagram depicting a food product monitoring system in accordance with one embodiment of the present disclosure.

FIG. 3 is a block diagram depicting the tracking of commercial appliance operating data in accordance with some embodiments.

FIG. 4 is a block diagram depicting the tracking of point of sale data in accordance with one embodiment.

FIG. 5 is a block diagram depicting the tracking of food product yield in accordance with one embodiment.

FIG. 6 is a block diagram depicting the tracking of a food product hold time in accordance with one embodiment.

FIG. 7 is a block diagram depicting the tracking of a food product hold time in accordance with one embodiment.

### DETAILED DESCRIPTION

### A. Overview

The present disclosure relates to a system and method for tracking data related to the preparation and sale of food in a restaurant. In one embodiment, the system and method may include tracking the amount of a food product prepared by a restaurant in relation to the amount of the food product which is sold by the restaurant (the “food product yield”). In an alternative embodiment, the system and method may include tracking the elapsed time between the preparation of a food product and the sale of the food product to a customer (the “food product hold time”). On the basis of this information, the system and method may generate reports detailing, for example, the food product yield and the food product hold times.

In some embodiments, the system and method of the present disclosure tracks data related to the preparation and sale of food in a restaurant by monitoring point of sale (“POS”) data and commercial appliance data. For purposes of this description, POS data may refer to any data related to the sale of a food product to a restaurant customer. For purposes of this description, commercial appliance data may to any data related to the operation of a commercial appliance.

The system and method of the present invention may be used by restaurants to, for example, more easily identify areas to improve profitability and customer satisfaction. For example, if a restaurant sells only a small fraction of the amount of a food product it prepares, the system and method allows for automated calculation of this statistic and thus enables restaurants to easily identify the issue and take appropriate remedial action. Additionally, for example, if a restaurant holds a food product after preparation for longer than a desired period, the system and method allows for automated calculation of this statistic and thus enables restaurants to easily identify the issue and take appropriate remedial action.

### B. System Configuration

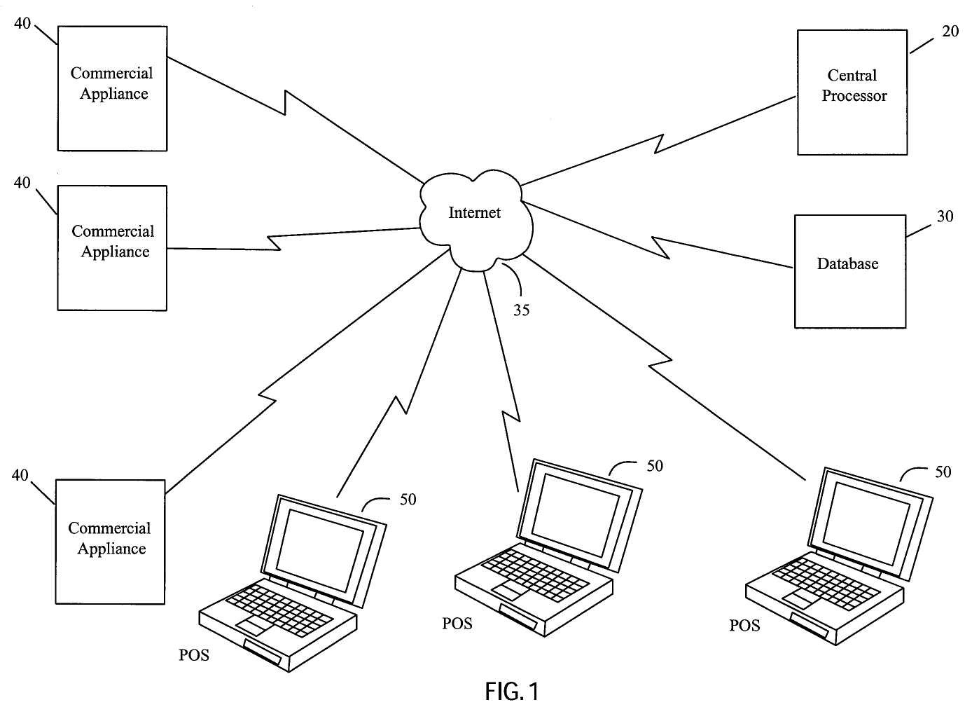

As shown in FIG. 1, the present disclosure in some embodiments relates to a food product monitoring system 10. In one embodiment, the system may comprise a central processor 20 located at a central location, one or more databases 30 to store system data, and a plurality of commercial appliances 40 located at a plurality of restaurant locations, each equipped with means to communicate with the central processor 20 and database 30 over the internet 35. The commercial appliances 40 may be located at different locations, at the same locations, or a mix thereof. Additionally, the system may comprise a plurality of point of sale (“POS”) interfaces 50 located at a plurality of restaurant locations, each equipped with means to communicate with the central processor 20 and database 30 over the internet 35. While the system is described with respect to an embodiment wherein the central processor 20 is at a location remote from the commercial appliances 40, it is to be appreciated that the central processor 20 may alternatively be provided at the location of the commercial appliances 40.

The central processor 20 can be any computer known to those skilled in the art, including standard attachments and components thereof (e.g., a disk drive, hard drive, CD player or network server that communicates with a CPU and main memory, a sound board, a keyboard and mouse, and a monitor).

The central processor 20 includes software programs or instructions that process requests and responses from a user of the monitoring system 10. These software programs or instructions send information to and receive information from the database 30, perform compilation and storage functions, and generate reports that may be used by users of the system 10. The software may be software applications commercially sold and normally used by those skilled in the art or they may be specific applications coded for use with the system disclosed herein.

The system 10 may also include one or more databases 30 for storing system data. The database may be of any type generally known in the art. In one embodiment, the databases 30 may be integral to the central processor 20. In an alternative embodiment, the databases 30 may be accessible to the central processor through a computer network or other suitable communication link, such as the Internet. In one embodiment, the database 30 is comprised of a plurality of database servers, some of which are integral to the central processor 20, and some that are located remotely from the central processor 20. In some embodiments, as will be discussed in greater detail below, the database 30 may store any information relating to the preparation and sale of restaurant food products. For the purposes of this description, the term “restaurant” may refer to an entity having a single site or an entity having a plurality of sites.

As shown, the system 10 may include one or more commercial appliances 40. In some embodiments, commercial appliances 40 may comprise any commercial appliance or combination of commercial appliances in which food products are prepared in batches. For example, commercial appliances 40 may include, without limitation, fryers, vegetable steamers, rice cookers, and the like.

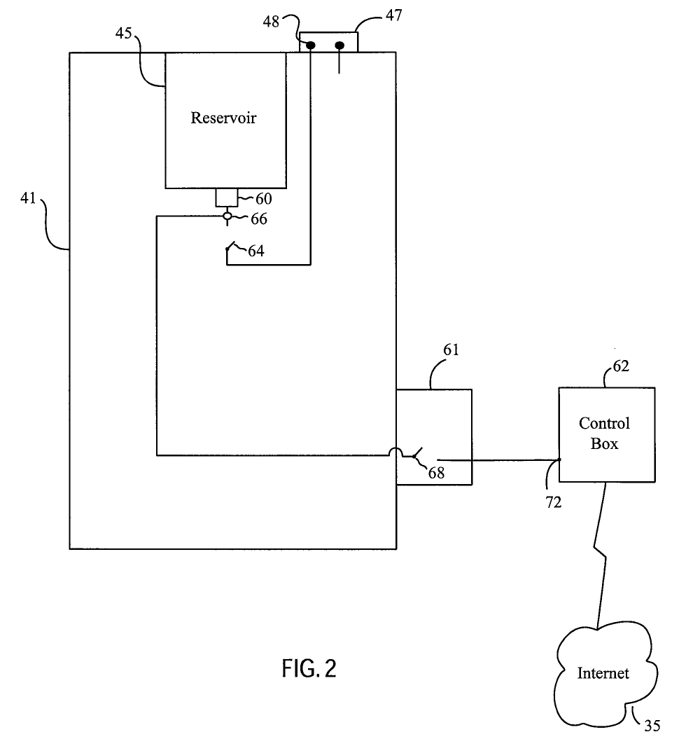

In one embodiment, illustrated in FIG. 2, commercial appliance 40 comprises a commercial fryer 41. Commercial fryer 41 may comprise any device known in the art for the preparation of food by means of heated cooking oil. As shown, commercial fryer 41 comprises a fryer having an oil reservoir 45 and a user interface 47. In alternative embodiments, a plurality of oil reservoirs may be provided. A fry cycle mechanism 60 may be associated with the commercial fryer 41.

As is conventional, user interface 47 may comprise a display for showing information relating to the operation of commercial fryer 41 and/or actuators for initiating or effecting operations within fryer 41. In one embodiment, user interface 47 comprises a fry cycle actuator 48. Any type of actuation mechanism may be used. For example, push button actuators may be used.

In some embodiments, embedded within the commercial fryers 41 is a fry cycle mechanism 60. For example, in one embodiment, fry cycle mechanism 60 may comprise a standard electromechanical valve, or solenoid valve, found in commercial fryers, which regulates the flow of fryer oil to and from the oil reservoir during operation of the appliance. The solenoid valve may be opened/closed by running/stopping an electrical current through the valve.

In some embodiments, the system 10 may track the data related to the preparation and sale of food products, in part, by monitoring preparation events of the fryers 41. For purposes of this description, a preparation event corresponds to the preparation of a batch of a food product. In the context of a commercial fryer, generally, a preparation event begins with an operator filling a fryer basket with a batch of uncooked food. The fryer basket is then lowered into a heated fryer oil reservoir and the food is cooked in the fryer oil for a predetermined amount of time. Removal of the fryer basket from the oil reservoir after the predetermined cooking time has expired concludes the preparation event. In some embodiments, data monitored by the system 10 includes the preparation event count and/or the date/time of each preparation event.

In one embodiment, tracking of the preparation events of the commercial fryer 41 may be achieved through operation of electronic components coupled to the fryer cycle mechanism 60. Specifically, in one embodiment, a fryer cycle switch 64, transducer 66, relay 68, and a control box 62 may be in electronic communication with the fryer cycle actuator 48 and fryer cycle mechanism 60. Fryer cycle switch 64 and transducer 66 may comprise any such standard components found in commercial fryers. Relay 68, in some embodiments, is housed in a relay box 70 which may be coupled to the external surface of fryer 40. Relay 60 may comprise any standard relay used by those skilled in the art.

In some embodiments, control box 62 provides a communication link between the fryer 41 and database 30 or central processor 20. Communication technology, such as a cellular modem, any other wireless communication system, and/or a landline communication system may be used to form a communication link between the control box 62 and database 30 or central processor 20.

Control box 62 may comprise any device capable of counting and telecommunications. Is some embodiments, the control box 62 may be capable of counting and communicating in real time. A suitable control box 62 for use with the system and method is a GT-100 Data Manager manufactured by Restaurant Technologies, Inc., of Eagan, Minn. In some embodiments, control box 62 includes a plurality of inputs for receiving signals regarding operation of the commercial fryer 41, such as triggering of a preparation event. Thus, as is described more fully below, the control box 62 may be used to perform a count of preparation events of the fryer 41. This may be referred to as establishing an event count.

In some embodiments, a sequence of operation of the fry cycle switch 64, transducer 66, relay 68 and control box 62 for tracking preparation events is as follows. The fry cycle switch 64, transducer 66, relay 68, and the control box 62 are in electronic communication with the fry cycle actuator 48 and fry cycle mechanism 60. Actuation of the fry cycle actuator 48 initiates the sequence. Actuation may be manual actuation by an operator, automated actuation, or other. In response to actuation of the fry cycle actuator 48, an actuation signal from the circuit for closing the fry cycle switch 64 is generated, thereby closing the switch 64 and causing current to be supplied to the fry cycle mechanism 60. The transducer 66 senses the current and generates a signal which is received by relay 68, thereby actuating relay 68. Once actuated, the relay 68 emits a signal which is received by control box input 72 and recorded by control box 62. This signal may be used to set an event count.

While the foregoing discussion regarding electrical components is described with reference to commercial fryer 41, it will be appreciated by those skilled in the art that the electrical components described herein may be similarly incorporated into any commercial appliance to monitor and track preparation events.

In some embodiments, the system 10 may include one or more POS interfaces 50. POS interfaces 50 may be any computer or computer systems used in the restaurant industry to process customer orders. In one embodiment, the POS interfaces 50 comprise a central processor unit and main memory, an input/output interface for communicating with various databases, files, programs, and networks (such as the Internet). The POS interfaces 50 may also have a monitor or other screen device and an input device, such as a keyboard, a mouse, or a touch sensitive screen.

### C. Commercial Appliance Operating Data

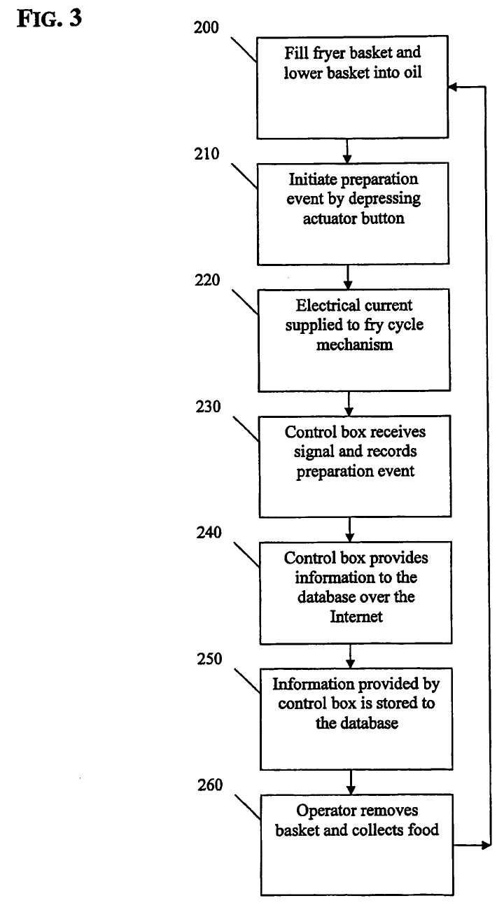

FIG. 3 is a flow chart illustrating the tracking of commercial appliance operating data in accordance with some embodiments. More particularly, FIG. 3 illustrates the tracking of preparation events of a commercial fryer in accordance with one embodiment. An operator fills a fryer basket with a batch of uncooked food having a known weight and at least partially immerses the basket in the fryer oil reservoir (block 200). The operator then initiates a preparation event by actuating the fryer cycle actuator 48 (block 210), thereby causing electrical current to flow to the fry cycle mechanism 60 (block 220). As described in detail above, the control box 62 then receives an electronic signal indicating that a preparation event has occurred (block 230). The control box 62 may then provide information to the database 30 (block 240). Provision of such information may be in real time or may, in some embodiments, be delayed, such as reporting of occurred events on a timed basis. In some embodiments, the control box provides any information relating to the preparation event. In one embodiment, the control box 62 provides either or both of the preparation event count (for example, indicating that +1 preparation event has occurred) and the date/time of the preparation event. The information provided by the control box 62 may then be stored to the database 30 (block 250). In some embodiments, the system saves all such preparation event information in the database 30 such that the system accumulates all preparation event history. After a predetermined cook time, the operator removes the fryer basket from the oil reservoir and collects the cooked food (block 260).

### D. POS Data

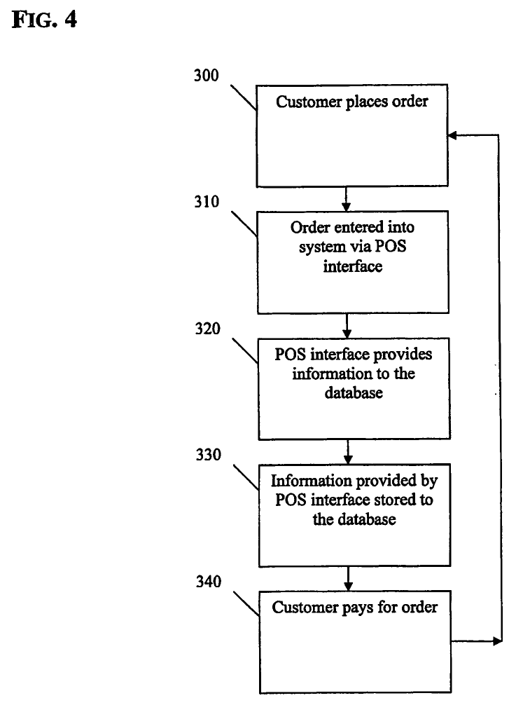

FIG. 4 is a flow chart illustrating the tracking of POS data in accordance with one embodiment. Typically, the process may be initiated by a customer placing an order with a restaurant employee (block 300). An order may, generally, consist of one or more food and/or drink items. Often times, each food and drink item has associated with it a “size” which corresponds to a predetermined quantity of food or beverage. For example, a customer may order a “medium” french fry, which may, for example, correspond to 6 oz. of french fries. The restaurant employee then enters the order into the system via the POS interface 50 (block 310). Alternatively, the customers themselves may enter orders into the system via a POS interface 50.

After an order is entered into the system, in some embodiments, the POS interface 50 provides information to the database (block 320). Provision of such information may be in real time or may, in some embodiments, be delayed, such as reporting of occurred events on a timed basis. In some embodiments, the POS interface 50 provides any information relating to the customer order. In one embodiment, if the customer order contains one or more food products (a “food product sale event”), for each food product sale event, the POS interface 50 provides any or all of the size (e.g., small, medium, large, etc.), type (e.g., french fries, onion rings, etc.), and date/time of the order. The information provided by the POS interface 50 may then be stored to the database 30 (block 330). In some embodiments, the system saves all such food product sale event information in the database 30 such that the system accumulates all food product sale event history. The customer may then conclude the order (block 340) by paying for the order. After conclusion of the order, another customer order may be placed (block 300).

It is to be appreciated that while reference is made to saving all preparation event and/or food product sale event information to accumulate all preparation event history and food product sale event history, a user may choose to delete information or to save less information. For example, in some embodiments, the system may be configured to delete information after it has been stored for a certain amount of time, such as on a weekly basis.

### E. Yield Tracking

In one embodiment, the system and method includes tracking food product yield. As discussed above, for purposes of the present disclosure, food product yield may refer to the amount of a food product prepared by a restaurant in relation to the amount of the food product sold by the restaurant

As an initial procedure, in some embodiments, information regarding the preparation and sale of a restaurant's food products available for purchase may be provided and stored to the database 30. In one embodiment, the stored information may include the batch weight of one or more of the restaurant's food products which are prepared, at least in part, by means of a commercial appliance. Additionally, in some embodiments, the stored information may include quantities in which a restaurant's food products are available for purchase. For example, food products may be available for purchase in quantities of small, medium, or large comprising a predetermined weight of food product of 4 oz., 6 oz., and 8 oz., respectively.

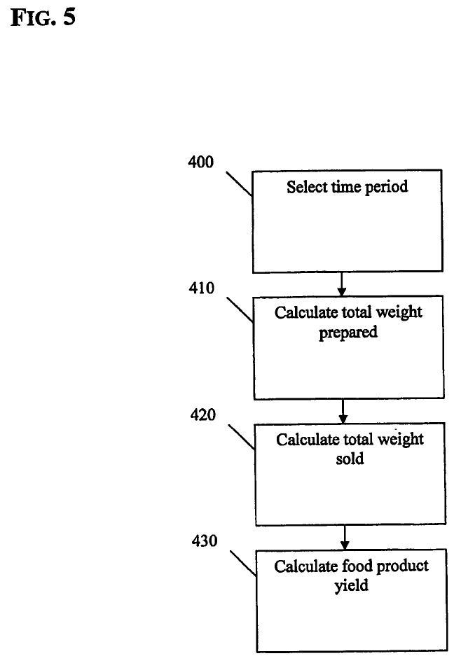

FIG. 5 is a flow chart illustrating the tracking of food product yield in accordance with one embodiment. As a preliminary step, in some embodiments, a time period over which the food product yield is to be calculated is selected (block 400). In one embodiment, the food product yield may be calculated for a selected day, week, month, or year. Alternatively, the restaurant's fryer yield may be calculated for any period of time.

According to some embodiments, the system 10 then performs calculations using information stored in the information. In one embodiment, the system 10 performs calculations using commercial appliance operating data and/or POS data.

In one embodiment, the system 10 may calculate the total weight of a given food product that was prepared over the selected period (“total weight prepared”) (block 410). In some embodiments, the system may calculate the total weight prepared by first totaling the number of preparation events which occurred for a food product over the selected period. The total weight prepared may then approximated by multiplying the total preparation events by the batch weight for the food product. For example, if over the selected period 10 preparation events occurred for a food product prepared in batches of 32 oz., the system may approximate the total weight prepared as 320 oz.

In one embodiment, the system 10 may calculate the total weight of the food product which was sold during the selected period (“total weight sold”) (block 420). In some embodiments, the system may calculate the total weight sold by first totaling the quantity of each size of the food product which was sold over the selected period. The system may then multiply the total quantity of each size sold by its associated weight to approximate the total weight of food product sold. For example, a food product may be sold in sizes of small, medium, and large comprising food weights of, for example, 4 oz., 6 oz., and 8 oz. respectively. If over the selected period quantities of such a food product sold was as follows: 10 small, 10 medium, and 10 large, the system may approximate the total weight sold as 40 oz.+60 oz.+80 oz.=180 oz.

In some embodiments, the system 10 may calculate the food product yield (block 430) by relating the total weight prepared to the total weight sold. In one embodiment, the food product yield may be calculated using the following equation:

$$\frac{[ Total weight sold ]}{[ Total weight prepared ]} \times 100 \%$$

### F. Hold Time Tracking

According to some embodiments, the system 10 may approximate food product hold times by performing calculations using information stored in the database. In one embodiment, the system 10 may perform calculations using commercial appliance operation data and/or POS data.

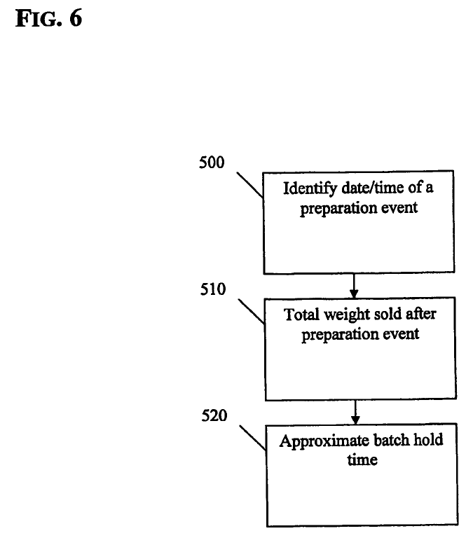

FIG. 6 is a flow chart illustrating the tracking of food product hold times in accordance with one embodiment. More specifically, FIG. 6 illustrates the tracking of a hold time for a batch of a food product (the “batch hold time”). For purpose of this description, the batch hold time may refer to the elapsed time between preparation of a batch of a food product and the time at which an amount of the food product corresponding to the batch weight is sold to customers. In one embodiment, the system 10 may calculate the batch hold time by first identifying the date/time of a preparation event of a food product (the “batch preparation time”) (block 500).

In some embodiments, the system may, using POS data, total the weight of the food product sold after the preparation time (the “total weight sold”) (block 510). The system may then approximate the batch hold time (block 520) as the elapsed time between the batch preparation time and the time at which the total weight sold exceeds the batch weight. For example, if at 12:00 pm a batch of a food product having a batch weight of 32 oz. was prepared, the system may approximate the batch hold time as the elapsed time between 12:00 pm and the time at which total weight sold exceeds 32 oz.

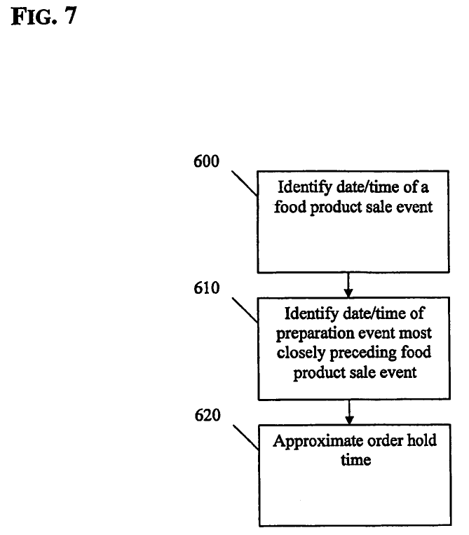

In an alternative embodiment, illustrated in FIG. 7, the system and method of the present disclosure may track the hold time for a food product served in a particular customer order (the “order hold time”). For purposes of this description, the order hold time may refer to the elapsed time between a customer order containing a food product and the most closely preceding preparation event for the food product.

In some embodiments, system 10 may identify the date/time of a food product sale event (block 600). The system may then identify the date/time of the preparation event for the food product which most closely precedes the date/time of the food product sale event (block 610). The system may then approximate the order hold time (block 620) by calculating the elapsed time between the identified events. For example, if a food product sale event occurred at 12:00 pm, and the most closely preceding preparation event for the food product occurred at 11:55 am, the system 10 may approximate the order hold time as 5 minutes.

### G. Report Generation

In some embodiments, on the basis of the stored commercial appliance operating data and the stored POS data, the system 10 may generate operation reports. For example, in one embodiment, a user of the system 10 may access the central processor 20 and prompt the system 10 to generate an operation report. In some embodiments, reports may be generated for a single restaurant. Alternatively, in some embodiments, reports may be generated for one or more restaurants which make up a restaurant enterprise. Further, the system may be configured to automatically generate reports after a triggering event has occurred, such as for example, a restaurant falling below a certain food product yield and/or exceeding a certain hold time. Alternatively, the system may be configured to automatically generate reports on a time basis (e.g., daily, weekly, etc.)

In some embodiments, operation reports may comprise any information relating to the preparation and sale of a restaurant's food products. In one embodiment, the operation reports may comprise operating statistics. For purposes of this description, operating statistics may comprise any statistic calculated through manipulation of stored commercial appliance data and POS data. In one embodiment, the operation reports may comprise one or more food product yields. In a further embodiment, the operation reports may comprise one or more food product hold times. In one embodiment, the operation reports may comprise either or both of batch hold times and order hold times.

Although the present invention has been described with reference to preferred embodiments, persons skilled in the art will recognize that changes may be made in form and detail without departing from the spirit and scope of the invention.

We claim:

1. A method for tracking data related to a food product comprising:
operating one or more commercial appliances;
establishing an event count each time a preparation event is carried out in the commercial appliance;
communicating each event count to a database;
maintaining event count information at the database;
operating one or more point of sale interfaces for processing customer orders;
communicating customer order information to a database;
maintaining customer order information at the database; and
generating operating reports, the operating reports being based on the event count information and/or customer order information.

2. The method of claim 1, wherein either or both of the event count information and customer order information are communicated remotely to the database.

3. The method of claim 1, wherein the commercial appliance comprises a commercial fryer.

4. The method of claim 1, wherein the operating reports comprise one or more food product yields.

5. The method of claim 4, wherein the food product yields are calculated by relating preparation events and food product sale events.

6. The method of claim 1, wherein the operating reports comprise one or more food product hold times.

7. The method of claim 6, wherein the hold times comprise batch hold times.

8. The method of claim 6, wherein the hold times comprise order hold times.

9. The method of claim 6, wherein the hold times are calculated by relating preparation events and food product sale events.

10. The method of claim 1, wherein the operating reports are automatically generated on a periodic basis.

11. The system of claim 1, wherein either or both of the control box and the point of sale interface send information to the database in real time.

12. A food product tracking system comprising:
one or more commercial appliances;
at least one control box, the control box being operatively associated with the one or more commercial appliances such that control box counts preparation events of the commercial appliance;
one or more point of sale interfaces for processing customer orders;
a database for storing information relating to preparation events and customer orders, the database being in communication with the control box such that the control box sends information regarding counted preparation events to the database, the database being in further communication with the point of sale interfaces such that the point of sale interface sends information regarding customer orders to the database; and
a central processor operatively associated with the database and including software for tracking food product information.

13. The system of claim 12, wherein either or both of the control box and the point of sale interface send information to the database remotely.

14. The system of claim 12, wherein the commercial appliance comprises a commercial fryer.

15. The system of claim 12, wherein the central processor further includes software for generating operating reports, the operating reports being based on the event count information and/or customer order information.

16. The system of claim 15, wherein the operating reports comprise one or more food product yields.

17. The system of claim 16, wherein the food product yields are calculated by relating preparation events and food product sale events.

18. The system of claim 12, wherein the operating reports comprise one or more food product hold times.

19. The system of claim 18, wherein the hold times comprise batch hold times.

20. The system of claim 19, wherein the hold times comprise order hold times.

21. The system of claim 18, wherein the hold times are calculated by relating preparation events and food product sale events.

22. The system of claim 15, wherein the operating reports are automatically generated on a periodic basis.

23. The system of claim 12, wherein either or both of the control box and the point of sale interface send information to the database in real time.

24. The system of claim 12, wherein either or both of the control box and the point of sale interface send information to the database periodically.
